(19) United States
(12) Patent Application Publication
(10) Pub. No.: US 2026/0249683 A1
(43) Pub. Date: Aug. 27, 2026

(54) VEHICLE WITH AN AUXILIARY AXLE

(71) Applicant: AUDI AG, Ingolstadt (DE)

(72) Inventor: Marko LINDNER, Kipfenberg (DE)

(21) Appl. No.: 19/543,686

(22) Filed: Feb. 18, 2026

(30) Foreign Application Priority Data
Feb. 21, 2025 (DE) 102025106662.0

(51) Int. Cl. B60K 23/08; B60W 10/02

(52) U.S. Cl. CPC B60K 23/08; B60W 10/02; B60K 2023/0858; B60W 2510/0291; B60W 2520/28; B60W 2710/021; B60W 2720/406; B60Y 2300/1865; B60Y 2300/42

(57) ABSTRACT

A vehicle is disclosed, and may include a main drive axle, an auxiliary axle, and at least one multi-plate clutch. The auxiliary axle may include a wheel hub, a cardan shaft, and at least one of a transmission and an electric motor. The cardan shaft may be mechanically connected to the at least one of the transmission and the electric motor. The at least one multi-plate clutch may be arranged between the wheel hub and the cardan shaft. The multi-plate clutch may be configured to selectively couple and decouple the auxiliary axle, such that the cardan shaft and the at least one of the transmission and the electric motor are stationary in a decoupled state. The multi-plate clutch may be configured to be operated with a slip in the decoupled state, such that no torque is transmitted by the multi-plate clutch in the decoupled state.

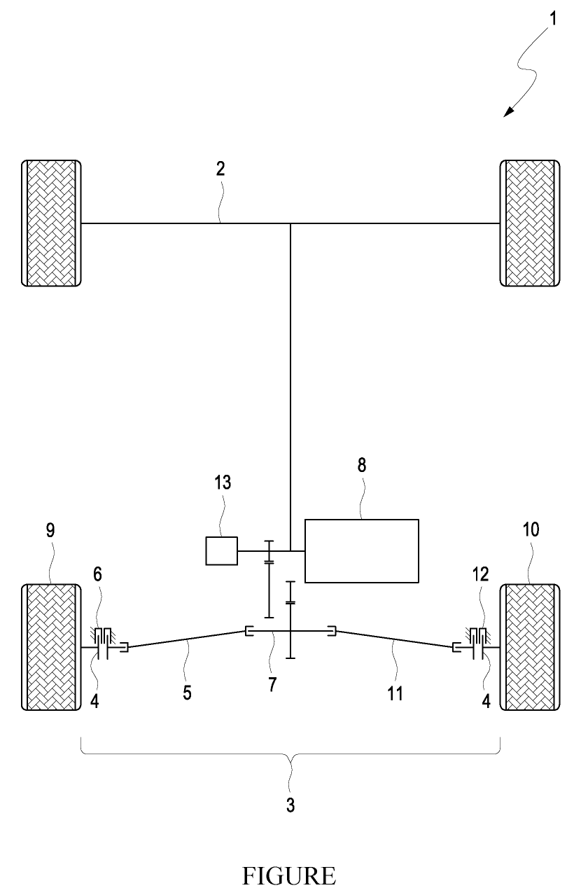

### BACKGROUND

### Technical Field

The present disclosure relates to a vehicle with a main axle and an auxiliary axle.

### Description of the Related Art

The state of the art comprises various technologies and solutions for controlling drive axles and clutch systems in vehicles. In particular, torque splitters, differential systems and clutches are described, which enable torque distribution and increased efficiency.

DE112013005384T5 describes an electric drive module for electric vehicles comprising a traction motor, a reduction gear unit, a differential unit for connecting axle shafts to wheels and a separating mechanism that may selectively couple or decouple the reduction gear unit and the differential unit in order to prevent torque transients and reversals.

DE102021132368A1 describes a wheel disconnect clutch comprising a housing, an axially displaceable clutch sleeve with teeth for connecting the wheel hub and half shaft, and a drive ring that moves the clutch sleeve between a coupled and uncoupled position.

CN105172573A describes a control system, a control method and a vehicle with a four-wheel hybrid drive. The drive system comprises a front axle unit with a front electric motor, an internal combustion engine and a front axle transmission as well as a rear axle unit with a rear electric motor.

### BRIEF SUMMARY

The present disclosure provides a vehicle with a main drive axle and an auxiliary axle and a method for controlling the same, which may enable efficient torque transmission and control.

The present disclosure relates to a vehicle with a main drive axle and an auxiliary axle, wherein at least one multi-plate clutch is arranged on the auxiliary axle between a wheel hub and a cardan shaft. The respective multi-plate clutch may be oil-lubricated and cooled and configured such that the multi-plate clutch may couple the auxiliary axle to the respective wheel hub and uncouple the auxiliary axle from the respective wheel hub. The auxiliary axle is in the uncoupled state when the auxiliary axle is uncoupled on both sides from the respective wheel hubs, as a result of which the cardan shaft, a transmission and/or an electric motor of the auxiliary axle may be stationary, wherein the cardan shaft may be mechanically connected to the transmission and/or to the electric motor. The multi-plate clutch may therefore be operated with slip in the uncoupled state, so that no torque is transmitted via the multi-plate clutch.

A main drive axle, such as a rear axle, refers to the primary drive axle of a vehicle that provides the majority of propulsion and is driven by a main drive, such as an electric motor. An auxiliary axle, such as a front axle, is an additional drive axle that is activated in specific operating states, for example to support traction or to increase performance, wherein the auxiliary axle may be driven by a second drive, such as a second electric motor. The multi-plate clutch is a mechanical component that transmits or interrupts torques between two rotating elements, which may be characterized by several friction surfaces, so-called plates. These plates may be alternately connected to the drive and output side, so that the activation of the multi-plate clutch, i.e., the coupling of the auxiliary axle to the respective wheel hub or a wheel associated with the respective wheel hub, creates a controlled frictional connection, which may be transmitted by the oil between the two friction surfaces with plates of the multi-plate clutch, for example in the form of turbines or fans. The advantage of oil lubrication of the multi-plate clutch is that the power transmission may occur without physical contact by way of the oil and therefore, the plates may not be worn or only slightly worn.

Oil lubrication refers to the use of a special lubricant, such as gear or engine oil, which is introduced between the plates and ensures power transmission. The oil may also serve as a heat carrier that dissipates the heat generated during operation of the multi-plate clutch.

The multi-plate clutch may be cooled actively or passively to keep the temperature inside the multi-plate clutch at an optimum level. Active cooling may be achieved by circulating the lubricating oil by way of an oil pump. The oil may be fed through an external or internal cooling circuit, where the oil transfers the heat to a cooling system. With passive cooling, heat may be dissipated by natural convection or via a housing surface of a multi-plate clutch housing equipped with cooling elements.

Operation with slip means that the multi-plate clutch may enable relative movement between the connected components, resulting in no frictional connection.

The advantages of the present disclosure may lie in the increased efficiency of the vehicle, as the auxiliary axle may not consume any unnecessary energy when uncoupled, as the cardan shaft and the transmission do not have to be moved. In addition, the slip control may prevent the multi-plate clutch from being overloaded.

Advantageously, in addition to a first multi-plate clutch on one side of the auxiliary axle between a wheel hub and a cardan shaft, a second multi-plate clutch may be provided on an opposite side of the auxiliary axle between a second wheel hub and a second cardan shaft, which may be uncoupled so that the cardan shaft, the transmission and/or the electric motor may be stationary in the uncoupled state.

Advantageously, the multi-plate clutch may be integrated in a closed housing, which may enable a circulation of lubricating oil for cooling and lubricating the plates.

A closed housing refers to a structure that completely encloses the multi-plate clutch and creates a controlled environment for lubrication and cooling and serves to seal against external influences such as dust, dirt or water. A closed housing may provide a controlled environment in which the oil may be efficiently distributed and the temperature can be kept constant.

A closed housing may enable efficient heat dissipation and lubrication, which increases the performance and durability of the multi-plate clutch.

Advantageously, the multi-plate clutch may be configured such that the multi-plate clutch compensates for speed differences between the wheels of the auxiliary axle, thereby replacing the function of a torque splitter and/or a differential.

A torque splitter is a device that distributes the torque variably between the wheels or axles of a vehicle. A differential enables speed differences between the wheels, especially when cornering. The differences in speed between the wheels of the auxiliary axle may be compensated for by the multi-plate clutch in several ways. One possibility is to operate the multi-plate clutch with controlled slip, in which the friction surfaces allow a limited relative movement between the drive sides. This allows the wheels to reach different speeds, for example when cornering, without the need for a mechanical differential. In addition, the contact pressure on the plates may be dynamically adjusted to the load conditions. Here, the contact pressure may be varied by a hydraulic or electric actuator so that a higher slip is achieved with low contact pressure, which may be particularly advantageous when cornering tightly or with uneven road grip. Moreover, the multi-plate clutch may be adaptively controlled by an electronic control unit that analyzes driving status parameters such as vehicle velocity, wheel speed and steering angle. On this basis, the slip of the multi-plate clutch may be controlled in real time in such a way that an optimum torque distribution is enabled, completely replacing the function of a torque splitter or differential.

The multi-plate clutch may eliminate an additional mechanical component, which may reduce the weight and complexity of the vehicle.

Advantageously, the multi-plate clutch may be controlled by an electronic control unit that takes parameters such as a wheel speed, a vehicle velocity and/or a driving mode into account.

The electronic control unit may be a system that processes sensor information and sends control commands to actuators in order to regulate vehicle functions.

The electronic control unit may enable the control of the multi-plate clutch to be flexibly adapted to the vehicle’s operating conditions, which may optimize efficiency and functionality.

Advantageously, the control of the multi-plate clutch may be configured in such a way that the uncoupling of the auxiliary axle takes place automatically in defined operating states, such as in a mode with a low power requirement, wherein the vehicle is only driven by the main drive axle.

The mode with a low power requirement is an operating state in which the vehicle only has minimal energy requirements, such as when driving downhill or idling.

This further reduces the vehicle’s energy consumption, which increases its range.

Advantageously, the multi-plate clutch may additionally be equipped with a temperature sensor that detects the temperature within the multi-plate clutch, wherein the multi-plate clutch may be controlled in such a way that overheating is avoided by switching the multi-plate clutch to slip as soon as a temperature limit value is exceeded.

The temperature sensor is a component that measures the temperature of a system and forwards this information to the control unit. The function of the multi-plate clutch with the temperature sensor may be configured to prevent overheating by adapting the operating mode of the multi-plate clutch to the thermal conditions. The temperature sensor, which may be located directly near the plates or inside the housing of the multi-plate clutch, may continuously measure the temperature. This temperature data is transmitted to an electronic control unit, which may analyze the data in real time. If the detected temperature exceeds a predefined limit value, the control unit may trigger control of the multi-plate clutch. In this case, the contact pressure of the plates may be reduced by the hydraulic or electric actuator, causing the multi-plate clutch to switch to slip mode. This mode allows the plates to slide against each other without complete frictional connection, which may significantly reduce heat generation through friction. At the same time, this operating state may promote heat dissipation, as the lubricating oil surrounding the plates may efficiently dissipate the excess heat. This control mechanism may enable dynamic adaptation of the clutch function to the thermal conditions without significantly restricting the functionality of the vehicle. When the temperature falls below the limit value again, the multi-plate clutch may be automatically switched back to normal operating mode. This prevents overheating, which may affect the service life of the multi-plate clutch or reduce performance thereof. As a result, overheating of the multi-plate clutch may be prevented, which may enable the safety and durability of the system.

It is understood that the features mentioned above and those to be explained below may be used not only in the combination indicated in each case, but also in other combinations or on their own, without departing from the scope of the present disclosure.

### BRIEF DESCRIPTION OF THE SEVERAL VIEWS OF THE DRAWINGS

The figure shows a schematic depiction of an embodiment of a vehicle according to the present disclosure.

### DETAILED DESCRIPTION

The figure shows a schematic depiction of a vehicle 1 with a main drive axle 2 and an auxiliary axle 3. The auxiliary axle 3 may comprise a first multi-plate clutch 6 arranged between a wheel hub 4 of a left wheel 9 and a cardan shaft 5. The first multi-plate clutch 6 may be oil-lubricated and cooled and may be configured to couple or uncouple the cardan shaft 5 of the auxiliary axle 3 to the wheel hub 4.

The left wheel 9 may be connected to the transmission 7 via the first multi-plate clutch 6 and the first cardan shaft 5. This multi-plate clutch 6 may enable transmission of torque from the auxiliary axle 3.

On the right-hand side, a right wheel 10 may be connected to the transmission 7 via a second cardan shaft 11 and a further second multi-plate clutch 12 between the right wheel 10 and the second cardan shaft 11. The second multi-plate clutch 12 may also be oil-lubricated and cooled and may be configured to couple or uncouple the cardan shaft 11 of the auxiliary axle 3 to the wheel hub 4 of the right wheel 10. When the first multi-plate clutch 6 and the second multi-plate clutch 12 are in the uncoupled state, the first cardan shaft 5, the second cardan shaft 11, the transmission 7 and the electric motor 8 may be stationary, which may reduce energy consumption.

The transmission 7 may be arranged centrally and may transmit the drive force of the electric motor 8 to the cardan shafts 5, 11 of the auxiliary axle 3.

The depicted configuration also shows that the multi-plate clutches 6, 12 may be configured designed in such a way that the multi-plate clutches 6, 12 may compensate for speed differences between the wheels 9, 10 of the auxiliary axle 3, thereby replacing the function of a torque splitter or a differential. In addition, the multi-plate clutches 6, 12 may be controlled via an electronic control unit 13, which takes into account parameters such as vehicle velocity, wheel speed and the driving mode.

German patent application no. 102025106662.0 filed February 21, 2025, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A vehicle comprising:
a main drive axle;
an auxiliary axle including a wheel hub, a cardan shaft, and at least one of a transmission and an electric motor, the cardan shaft being mechanically connected to the at least one of the transmission and the electric motor; and
at least one multi-plate clutch arranged between the wheel hub and the cardan shaft of the auxiliary axle, the at least one multi-plate clutch being oil-lubricated and cooled,
wherein the at least one multi-plate clutch is configured to selectively couple the cardan shaft of the auxiliary axle to the wheel hub and to selectively decouple the cardan shaft of the auxiliary axle from the wheel hub,
wherein the multi-plate clutch is configured such that the cardan shaft and/or the at least one of the transmission the electric motor of the auxiliary axle are stationary when the at least one multi-plate clutch decouples the cardan shaft of the auxiliary axle from the wheel hub, and
wherein the at least one multi-plate clutch is configured to operate with a slip in a decoupled state, such that no torque is transmitted by the at least one multi-plate clutch in the decoupled state.

2. The vehicle according to claim 1, wherein the multi-plate clutch is integrated in a closed housing configured to enable circulation of lubricating oil for cooling and lubricating plates of the multi-plate clutch.

3. The vehicle according to claim 1, wherein the multi-plate clutch is configured such that, in a coupled state, the multi-plate clutch compensates for speed differences between wheels of the auxiliary axle.

4. The vehicle according to claim 1, wherein the multi-plate clutch is controlled by an electronic control unit based on account parameters including at least one of a wheel speed, a vehicle velocity, and a driving mode.

5. The vehicle according to claim 4, wherein control of the multi-plate clutch is configured such that decoupling of the multi-plate clutch occurs automatically in low power operating states, low power operating states including operating states in which a drive of the vehicle is effected only by the main drive axle.

6. The vehicle according to claim 1, wherein the multi-plate clutch includes a temperature sensor configured to determine a temperature within the multi-plate clutch, and
wherein the multi-plate clutch is configured to be controlled such that overheating is avoided by switching the multi-plate clutch to slip in response to a limit value of the temperature being exceeded.

7. A method for controlling a vehicle, the method comprising:
detecting driving status parameters including at least one of wheel speed, vehicle velocity, and driving mode;
analyzing the detected driving status parameters in an electronic control unit; and
based on the analyzed driving status parameters, one of:
automatic coupling of a multi-plate clutch of an auxiliary axle of the vehicle, coupling of the multi-plate clutch including coupling a cardan shaft of the auxiliary axle to a wheel hub of the auxiliary axle; or
automatic decoupling of the multi-plate clutch of the auxiliary axle, decoupling of the multi-plate clutch includes decoupling the cardan shaft of the auxiliary axle from the wheel hub of the auxiliary axle,
wherein the multi-plate clutch is arranged between the wheel hub and the cardan shaft of the auxiliary axle, the at least one multi-plate clutch being oil-lubricated and cooled,
wherein the vehicle includes a main drive axle,
wherein the auxiliary axle includes at least one of a transmission and an electric motor, the cardan shaft being mechanically connected to the at least one of the transmission and the electric motor, and
wherein the multi-plate clutch is configured such that the cardan shaft and/or the at least one of the transmission the electric motor of the auxiliary axle are stationary when the at least one multi-plate clutch decouples the cardan shaft of the auxiliary axle from the wheel hub.

8. The method according to claim 7, wherein the multi-plate clutch is configured to operate with slip in a decoupled state, such that no torque is transmitted by the multi-plate clutch when in the decoupled state.

9. The method according to claim 7, wherein the electronic control unit is configured such that when a temperature in the multi-plate clutch exceeds a fixed limit value, the electronic control unit places the multi-plate clutch in a decoupled state.
